(19) United States
(12) Patent Application Publication
(10) Pub. No.: US 2019/0151891 A1
(43) Pub. Date: May 23, 2019

(54) METHOD FOR OBTAINING A METALLIZED SURFACE HAVING A DESIGN

(71) Applicant: COATEC PACK EN ABREGE CTP, Lons-Le-Saunier (FR)

(72) Inventors: Mathieu LEYRE, Plaisia (FR); Erwin ENETTE, Quintigny (FR)

(21) Appl. No.: 16/091,729

(22) PCT Filed: Apr. 14, 2017
(86) PCT No.: PCT/EP2017/059064

§ 371 Date: Oct. 5, 2018

(30) Foreign Application Priority Data
Apr. 18, 2016 (FR) 1653424

(51) Int. Cl. B05D 5/06; B05D 7/00; B05D 3/06

(52) U.S. Cl. CPC B05D 5/068; B05D 3/067; B05D 7/57

(57) ABSTRACT

The invention relates to a new method for metallizing a surface, in particular of a solid packaging, allowing said surface to be entirely or locally personalized by modifying the reflective properties of the deposited metal layer. The invention also relates to the metallized surface obtained in said manner.

### FIELD OF THE INVENTION

The present invention concerns a new method for metallizing a surface, in particular of solid packaging, allowing a total or local customization of this surface by modifying the reflective properties of the deposited metal layer. The invention also concerns the metallized surface thus obtained.

### STATE OF THE ART

Known methods for metallizing surfaces are used, particularly on plastic, to give a metallic appearance to cosmetic packaging or on large parts such as vehicle body parts, or to produce caps for bottles of spirits or perfumes (WO 2008/035186). These methods consist in treating the surface of the part to be metallized with a base layer (or “basecoat”) of polymer so as to cover the part's imperfections and to obtain a smooth and perfectly flat surface state, then depositing a layer of metal, for example aluminium, by evaporation or sputtering, then covering the metal layer with an upper layer (or “topcoat”) of polymer, which is for example transparent, so as to protect the metal layer.

This well-known method makes it possible to produce smooth metal surfaces with a glittering and reflective mirror-like appearance, but does not allow the customization of certain areas, such as the creation of rough areas representing a particular design, or at least imperfectly.

It is possible to customize metal parts by locally modifying the appearance of the surface, for example by stamping, anodizing or chemical treatment. However, these techniques are limited to a metal support and expensive to implement.

It is also proposed to modify the state of the surface to be metallized before application of the basecoat, for example by graining in the mould of the injected parts. But these unwieldy and expensive techniques give a crude result, the roughness created on the surface to be treated being attenuated by the application of different layers.

As for the treatment after metallization, on the surface of the topcoat, it is very limited technically since the treatment will alter, in a way that is difficult to control, the physicochemical properties of the metallized surface, particularly from a visual point of view.

Some have proposed printing a design on the surface of the basecoat before metallization using conventional printing techniques, such as inkjet printing (WO 2013/087058) or screen printing (US 2005/219626), using conventional printing inks. These printed designs appear in slight relief on the basecoat which is visible after metallization. However, the use of conventional inkjet or screen-printing inks does not modify the reflective properties of the deposited metal layer. The effect obtained, if visible, does not appear as a modification of the state and the reflective properties of the surface. The effect obtained is the identification of a slight relief possibly visible on the second surface and does not allow a substantial and precise visual contrast effect associated with a modification of the reflective properties of the surface after deposition of the metal layer.

There is a need to develop a new metallization method which allows a single and customizable deposition, which is adaptable to any type of support, which is precise, and which is more economical to implement. It will consist in locally modifying the appearance and texture of the deposited metal layer, in particular its reflective properties.

### DISCLOSURE OF THE INVENTION

The present invention concerns a new method for metallizing a surface comprising applying (i) a base layer or “basecoat”, (ii) a metal layer, then (iii) an upper layer or “topcoat” to protect the metal layer, characterized in that the surface state of the basecoat is modified before applying the metal layer so as to modify the reflective properties of the surface after metallization.

This modification of the surface state of the basecoat is achieved advantageously by modifying the surface of the basecoat by depositing fillers on the surface of the basecoat before applying the metal layer.

The surface modification can be done advantageously by transferring or printing an ink comprising said fillers on the surface of the basecoat.

The modification of the surface state of the basecoat can be done on all or part of the surface to be metallized. Preferably, the modification of the surface of the basecoat, in particular by deposition of fillers, preferably the deposition of an ink comprising said fillers, is done according to a predetermined design to create a particular visual effect on the finished product.

A preferential embodiment of the invention consists in depositing, by printing, on the basecoat an ink layer comprising an inorganic or organic filler intended to create a relief. The surface state of this new layer will make it possible to modify the structure of the metal then deposited, and consequently to modify the reflective properties of the metal layer, as opposed to the mirror appearance conventionally obtained.

### DETAILED DESCRIPTION OF THE INVENTION

The present invention concerns a new method for metallizing a surface comprising applying (i) a basecoat, (ii) a metal layer, then (iii) a topcoat to protect the metal layer.

The products and methods used for these steps are well known to the skilled person.

In particular, the basecoat is composed of monomers, pre-polymers or polymers, formed into a network via a polymerization reaction. Particular examples include polymerization by condensation under the possible action of temperature (polyurethanes, polyesters, melamine-formaldehyde, etc.) or by addition (polyvinyl chloride, polyvinyl acetate, etc.). In our example, we will cite in particular the possible presence of acrylate functionalized monomers and oligomers (epoxy acrylate, urethane acrylate, acrylic acrylate, polyester acrylates). The oligomer consists of a short polymer chain terminated at each end by one or more reactive functions which, by polymerizing, will give rise to a three-dimensional polymer network.

The monomer has one or more reactive functions, which make it possible to adjust the viscosity of the selected oligomer and which, after polymerization, will be incorporated into the polymer network.

A photoinitiator will initiate the radical polymerization reaction when subjected to UV radiation. Photolysis releases reactive species (free radicals) to the functional group of the oligomer.

This basecoat, which can be applied by various methods, will be for example sprayed onto the substrate. After possible evaporation of the solvents contained in this layer (the solvent making it possible to adjust the viscosity of the formulation according to the application method), the support coated with the basecoat will be subjected to UV radiation which will trigger its polymerization and the creation of a dry polymer film.

The basecoat generally has a thickness comprised between about 5 and 50 μm.

The metal layer can consist of one or more metals (aluminium, chrome, nickel, indium, etc.). It will be deposited by vacuum evaporation, sputtering (PVD), spraying or any other method for depositing a thin layer of metal on a support.

In the case of evaporation, the presence of a high vacuum within the enclosure is important insofar as the establishment of this vacuum decreases the sublimation temperature of the material which, subjected to an energy source, is then brought to its saturated vapour pressure and evaporated to settle on the surface of the substrate (substantially direct trajectory related to the average free path of the species made possible under vacuum).

The topcoat will generally use constituents of the same chemical nature as the basecoat described above. It may consist of isocyanates and polyols, leading to a polyurethane system under the action of temperature, or any other chemical nature. In our example, a formulation containing acrylate functionalized monomers and oligomers will protect the previously deposited metal layer after UV curing.

The method of the invention differs from previous methods by the fact that the surface state of the basecoat is modified before applying the metal layer so as to modify the reflective properties of the surface after metallization. This modification creates a heterogeneous surface state. The metal layer then deposited will conform to this surface state, which will give it new reflective properties, in singular contrast with the mirror-like reflection normally obtained within the context of a metallization treatment.

The differences in reflective properties, or differences in reflectivity/reflectance of two metallized surfaces, are easily visible to the naked eye by the skilled person. The untreated area, or area of homogeneous surface reflectivity, behaves like a mirror while the area treated to obtain a heterogeneous state will appear more matte and rougher.

These differences in reflective properties can be quantified by measurement methods known to the skilled person, in particular with a gloss meter (but often limited due to the presence of metallized surfaces), preferably with a gonioreflectrometer. A small difference is enough to obtain a difference perceived to the naked eye by a person of average attention. Simple measurements using a gloss meter show ratios of the order of 50 to 200 between a mirror surface and a surface whose basecoat has been modified.

This modification of the surface state of the basecoat is achieved advantageously by depositing fillers on the surface of the basecoat.

This surface modification can be done by depositing a printing layer, or ink, comprising said fillers to create a different surface state on the surface of the basecoat.

Preferably, the modification of the basecoat is done according to a predetermined design to create a particular visual effect on the finished product.

A preferential embodiment of the invention consists in depositing, by printing or transfer on the basecoat, a printing layer comprising an inorganic or organic filler, which will create a surface state different from the basecoat and a relief. The surface state of this new layer will make it possible to modify the structure and the reflective properties of the metal then deposited.

According to the invention, “printing” means any printing method, in particular the screen printing, pad printing, offset, flexography, rotogravure, digital printing, inkjet techniques.

According to the invention, “transfer” means any technique for depositing, on all or part of the surface of the basecoat, a printing composition intended to modify the surface state of the support to be treated according to a predetermined design. Particular examples include hot stamping, cold stamping and image transfer techniques.

Advantageously, this deposition will be done using an ink, by the screen-printing technique.

Advantageously, the printing composition comprises an inorganic or organic filler to modify the surface state of the basecoat. The surface state of the ink, which is heterogeneous, has a texture/roughness defined by the formulation work, the nature of the fillers used, their particle size, their proportion in the printing composition.

The skilled person will be able to modulate these composition parameters according to the desired result and the transfer method. In particular, the printing composition, or ink, comprises a binder and an inorganic and/or organic filler.

The binder is a common polymer composition used in the composition of screen-printing inks, in particular epoxy resins, polyols, acrylate oligomers, acrylic or vinyl thermoplastic resins and mixtures thereof.

Advantageously, the binder contains UV-sensitive components to allow curing of the composition after application.

Advantageously, the binder comprises a mixture of acrylate oligomers and monomers. Particular examples include the commercially available acrylate oligomers manufactured by the companies ALLNEX and SARTOMER under the names EBC648, EBC8465, EBC 745, EBC3708, CN2610, CN9276 and certain acrylate monomers with different functionalities: ODA, HDDA, TPGDA, TMPTA, PETIA, SR256.

The fillers can be inorganic or organic, or even a mixture of inorganic and organic fillers depending on the desired effect. The fillers consist of particles which are essentially spherical, elliptical or potato-shaped or of any other nature.

They preferably have a particle size ranging from 1 to 50 μm, measured according to the standard particle size measurement methods. Particular examples include the principal measurement methods, by sedimentometry, analytical centrifugation, laser diffraction, microscopy.

More preferentially, the fillers have a particle size ranging from 2 to 20 μm.

The skilled person will know how to choose the particle size of the fillers according to the desired effect. He or she may use a mixture of fillers of different nature (inorganic or organic) and particle sizes.

Particular examples of inorganic fillers include particles of silica, quartz, mica, kaolin, which can be used in their crude form or after benefiting from a particular treatment (organic surface treatment), and mixtures thereof.

Particular examples of organic fillers include particles of polymers PMMA, PS, derivatives of polyamides, polyimides, polyolefins, polurethanes, polypropylene, polyesters and mixtures thereof.

Particular examples include the products available on the market manufactured by the companies BYK, GRACE, NEGAMI, EVONIK, FINMA, LAPASSE, SYLISIA under the names Syloid 244, OK 607, FINMATT 121V, C-800T, Sylisia 276, Sylisia 430, Ceraflour 913, Ceraflour 914, Ceraflour 994, OMICRON NPS, ACEMATT 3300. The cited products will be used in proportions between 1 and 20% by mass in the final formulation.

The printing composition or ink used for the method according to the invention preferably comprises from 5 to 18% by mass of inorganic filler, in particular for the fillers of preferred particle sizes defined above.

In addition to the particle size of the fillers, their content distinguishes the printing compositions used in the method according to the invention to modify the surface state from the compositions comprising inorganic pigments usually used for inkjet or screen printing.

After deposition, the proportion and the particle size of the fillers used create a new heterogeneous surface alternating binder and filler, each having distinct reflective properties, which differently affect the reflectivity of the metal layer deposited thereon.

The printing composition may also comprise, in addition to the binder and fillers, any usual additive known to the skilled person to influence the rheological properties of the inks, their ability to properly wet the substrate, to initiate the polymerization reaction, or to properly disperse the inorganic and/or organic fillers. These are notably products from the manufacturers EVONIK AND BASF, namely the products TEGO WET 270, 500, 280 used for their wetting function, the products TEGO FOAMEX 3062, 810 and 850 for their defoaming properties, the products TEGO AIREX 920, 980 for their deaerating properties, the products TEGO RAD 2100, 2300, 2500 for their flow and slip properties, the products IRGACURE 184, TPO, IRGACURE 819, IRGACURE 754 as UV-sensitive polymerization-triggering photoinitiators, the products TEGO DISPERS 652, 685, 655 to facilitate the dispersion of inorganic or organic fillers. The cited products will be used in proportions comprised between 0.1 and 10% by mass in the final formulation.

Advantageously, the printing composition is cured by UV treatment. The skilled person knows the usual means and the usual operating conditions for curing inks.

The printing composition is preferably applied by screen printing.

Particular attention will be paid to the choice of screen-printing screen. Indeed, the choice of mesh, defined by two numbers (number of threads/cm, thread diameter) will define the thickness of ink deposited, and consequently the surface state obtained. A 140-31 type screen, providing a good compromise between the thickness deposited and the surface state obtained, is described in the examples below. Of course, the skilled person will know how to select the appropriate mesh screen according to the desired result.

Also, the choice of squeegee and its hardness will allow a perfectly homogeneous deposition to be obtained. A squeegee with a hardness of between 60 and 90 shores will be preferentially selected. The printing speed and pressure applied on the screen will also be taken into account, based on parameters well known to the skilled person.

According to a preferred embodiment of the invention, a printing composition having a thickness of about 5 to 40 μm is applied to the basecoat, prior to step (ii) of applying the metal layer, in particular by screen printing.

Preferably, the printing composition is cured by any appropriate means, in particular treatment with UV radiation, prior to application of the metal layer.

The fillers deposited on the surface of the basecoat thus allow the metal layer to be structured according to this modified surface state. Indeed, the metal layers generally have a thickness of a few hundred angstroms, so that the application of this thin layer conforms to the roughness of the surface of the basecoat and the metal layer is structured according to the nature of the surface on which it is applied, basecoat, filler or ink binder.

The thickness of the topcoat, which can range from about 5 to 50 μm, will depend on the desired effect. If this layer is applied in a thin layer, advantageously having a thickness of about 5 to 20 μm, then it will also conform to the reliefs of the metal layer, which can be felt to the touch. The skilled person can also decide to apply the topcoat in a thicker layer, generally of 20 to 50 μm, so as to eliminate (embed) the roughness in order to create a surface that is smooth to the touch and has the obvious advantage of a high surface gloss.

The method according to the invention has many advantages over known methods, notably:
technical and industrial flexibility compared with existing unwieldy methods;
the quality of the results;
infinite customizability according to the aesthetic criteria of the end user, fineness of textures and multiplicity of possible contrasts.

The present invention also concerns a metallized surface obtainable by the method described above and in the examples.

The surface metallized by the method according to the invention is a plastic surface, in particular (PP, ABS, PET, PVC, PCTG, PETG, PA, etc.), a glass surface or a metal surface.

The application of the printing composition by silkscreen makes it possible to create designs of any kind, such as names, abstract or concrete decorative designs, photographs, etc.

In particular, it concerns a product, container or packaging for cosmetic products, the surface of which is metallized by the method according to the invention.

Other features of the invention will become apparent by reading the following examples.

### DESCRIPTION OF THE FIGURES

FIG. 1 shows a metallized surface according to the state of the art with the surface to be metallized (1), the basecoat (2), the metal layer (3) and the topcoat (4).

FIG. 2 shows the surface metallized with the method described in the state of the art when a conventional printing layer without fillers (5) is applied to the basecoat (2) to create a relief without modification of the surface state. The metal layer (3) follows this relief without modification of its reflective properties.

FIG. 3 shows a surface metallized with the method of the invention when fillers (6) are deposited on the surface of the basecoat with an ink containing the fillers according to the invention. The surface thus created comprises an alternation of unmodified areas (5) and areas whose surface state is modified by the presence of fillers (6), each having different reflective properties. This heterogeneity of reflectivity is found on the surface of the metal layer 3, depending on whether it is deposited on the untreated surface (3a) or on the fillers (3b).

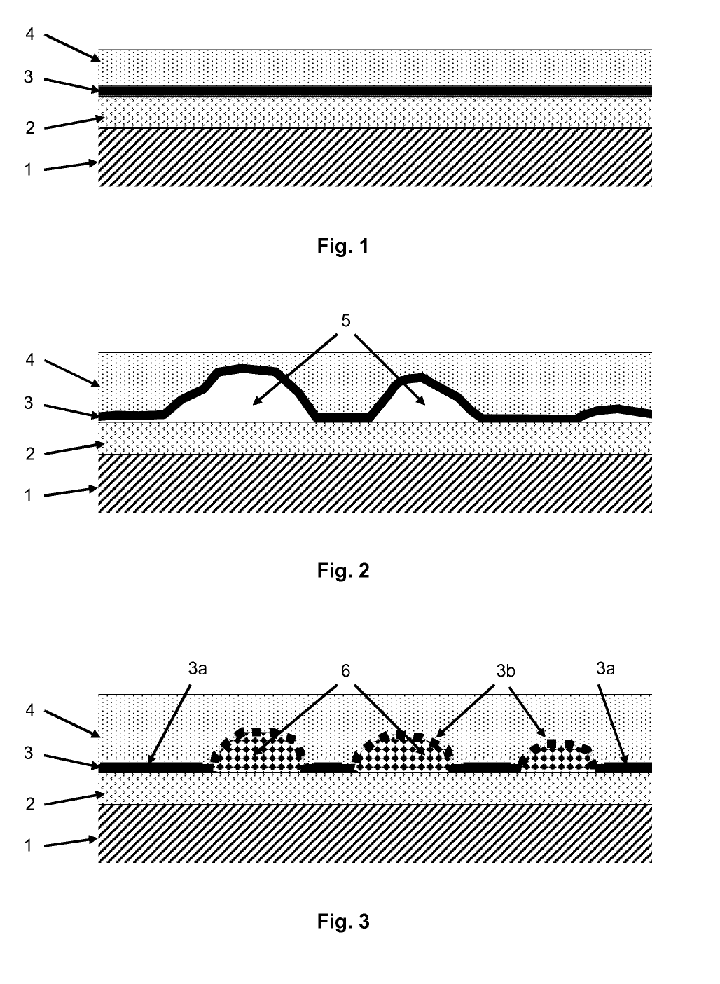

### EXAMPLES

### Example 1: Ink Formulation

| Components | Weight % |
|---|---|
| PETIA | 38.48 |
| CERAFLOUR 913 | 12.28 |
| EBC 8465 | 16.37 |
| IRGACURE 184 | 4.87 |
| HDDA | 27.02 |
| FOAMEX 810 | 0.49 |
| RAD 2100 | 0.49 |
| Total | 100 |

PETIA: Pentaerythritol triacrylate, acrylate monomer, which constitutes the binder of the formulated UV ink, manufactured by ALLNEX
CERAFLOUR 913: Micronized polypropylene wax, for creating the desired surface state, manufactured by BYK
EBC 8465: UV-curable aliphatic urethane triacrylate, acrylate oligomer which constitutes the binder of the formulated UV ink, manufactured by ALLNEX
IRGACURE 184: Photoinitiator used to initiate radical polymerization of the acrylate reactive species present in the ink, manufactured by BASF.
HDDA: HEXANEDIOL DIACRYLATE, difunctional acrylate monomer used for the formulation of UV-cured components in particular, manufactured by ALLNEX.
FOAMEX 810: Defoamer used in the manufacture of inks, manufactured by EVONIK
RAD 2100: UV-curable additive, for its flow and wetting properties, manufactured by EVONIK.

### Example 2: Preparation of a Metallized Mascara Tube

1. An adhesion primer for polyolefins is sprayed onto a blow-moulded plastic (PP) part. Rapid drying at room temperature allows the residual solvents in the primer to evaporate.
2. The basecoat described above is then sprayed on. The residual solvents present on the part are evaporated by exposure to hot air (hot air tunnel or IR lamps). The basecoat is then exposed to UV radiation which will polymerize the different reactive species present in the formulation.
3. The ink described in example 1 is then deposited by screen printing, according to a design predefined during the manufacture of the silk screen. Silk screen characteristics: 140-30. This is then exposed to UV radiation to cause it to polymerize.
4. A thin layer of aluminium is then deposited by evaporation in a vacuum chamber. This metal layer conforms to the surface state of the ink, giving it a unique structure and visual properties.
5. The topcoat described above is then sprayed on. As with the basecoat, the residual solvents are evaporated, and polymerization takes place under UV radiation.

### REFERENCES

WO 2008/035186
US 2005/219626
WO 2013/087058

1. A method for metallizing a surface comprising successively applying (i) a basecoat, (ii) a metal layer, and then (iii) a topcoat to protect the metal layer, wherein the surface state of the basecoat is modified before applying the metal layer by transfer or printing of a printing composition comprising inorganic and/or organic fillers and a binder, the amount and the particle size of inorganic and/or organic fillers in the printing composition are selected to create upon transfer a heterogeneous surface alternating binder and filler so as to modify the reflective properties of the surface after metallization.

2. (canceled)

3. (canceled)

4. (canceled)

5. The method of 1, wherein the inorganic fillers are selected from particles of silica, quartz, mica, kaolin, and mixtures thereof.

6. The method of claim 1, wherein the organic fillers are selected from particles of polymers PMMA, PS, derivatives of polyamides, polyimides, polyolefins, polurethanes, polyesters and mixtures thereof.

7. The method of 1, wherein the fillers have a particle size ranging from 1 to 50 μm.

8. The method of claim 1, wherein the binder comprises a mixture of polymers selected from epoxy resins, polyols, acrylate oligomers, acrylic or vinyl thermoplastic resins and mixtures thereof.

9. The method of claim 1, wherein the printing composition comprises from 5 to 18% by mass of inorganic fillers.

10. The method of claim 1, wherein the printing composition is cured by treatment with UV radiation.

11. The method of claim 1, wherein the printing composition is deposited by transfer on the basecoat.

12. The method of claim 11, wherein the transfer is done by screen printing.

13. (canceled)

14. The method of claim 1, wherein the printing composition on the basecoat has a thickness of 5 to 40 μm.
